(19) United States
(12) Patent Application Publication
(10) Pub. No.: US 2005/0044834 A1
(43) Pub. Date: Mar. 3, 2005

(54) Lawnmower and trimmer

(76) Inventor: Richard Appleyard, Russellville, AL (US)

Correspondence Address: Richard C. Litman;LITMAN LAW OFFICES, LTD., P.O. Box 15035, Arlington, VA, 22215, US

(21) Appl. No.: 10/924,928

(22) Filed: Aug. 25, 2004

Related U.S. Application Data
(60) Provisional application No. 60/497,716, filed on Aug. 26, 2003.

(51) Int. Cl. A01D 34/00

(52) U.S. Cl. 56/12.7

(57) ABSTRACT

The lawnmower and trimmer apparatus is a lawnmower modified to incorporate grass trimmer. A first embodiment provides a slot on one sidewall of the lawnmower deck for providing space for the trimmer string to protrude above the mower blade. The second embodiment provides rotation of a tilted grass trimmer unit by a belt drive assembly including a belt tensioner that works off the rotation of the lawnmower's power shaft. The grass trimmer unit is located outside the lawnmower deck at the left front corner of the deck and tilted towards the deck. A third embodiment positions a belt driven grass trimmer unit at the left front corner of the deck, and includes a belt tensioner unit below the deck.

### CROSS-REFERENCE TO RELATED APPLICATION

This application claims the benefit of U.S. Provisional Patent Application Ser. No. 60/497,716, filed Aug. 26, 2003.

### BACKGROUND OF THE INVENTION

1. Field of the Invention

The present invention relates generally to grass cutting machines. More specifically, the invention is a combination lawnmower and a grass trimmer machine.

2. Description of the Related Art

The related art of interest describes various lawnmower apparatus and various grass trimmer or weed cutter apparatus, but none discloses the present invention. Presently one must first mow the lawn with a lawnmower, and then trim the lawn with a grass or weed trimmer. There is a need for an economical, durable lawnmower combined with a grass or weed trimming machine. The related art of interest will be discussed in the order of perceived relevance to the present invention.

U.S. Design Pat. No. 359,291, issued on Jun. 13, 1995 to Albert J. Tihonovich, shows an ornamental design for a mower with a line weeder/trimmer attachment. The drawings show a lawnmower deck with a semicircular cutout located behind the left front wheel to accommodate a string trimmer unit.

U.S. Pat. No. 3,531,922, issued on Oct. 6, 1970 to Louis H. Hansen, describes a trimmer and edger attachment device for a power mower which is attached to the front right corner of the lawnmower deck in front of the offset front wheel and adjacent the cut grass exhaust port. Both the trimmer and the edger have blades mounted on shafts housed in a bracket extending from the lawnmower deck, the shafts being driven from the lawnmower shaft by a belt and pulley mechanism and a gear mechanism, respectively.

U.S. Pat. No. 4,703,613, issued on Nov. 3, 1987 to Richard O. Raymond, describes a two-wheeled mowing and trimming apparatus comprising a rotating cutting head with nylon filaments or cutting blades, but not together. The frame can be tilted by a handle.

U.S. Pat. No. 4,718,221, issued on Jan. 12, 1988 to Lloyd E. Wessel et al., describes a rotary lawnmower edger and trimmer apparatus comprising an edger consisting of a metal disc mounted on either the left side or in front of the mower deck.

U.S. Pat. No. 4,896,488, issued on Jan. 30, 1990 to Larry A. Duncan et al., describes a trimming attachment device for a power lawn mower comprising a protective casing extending out on the left side of the mower housing or skirt to house the pulley driven grass trimmer. The grass trimmer can be disengaged by removing the drive belt from the pulleys, whereupon a portion of the protective casing can be pivoted upward and clamped above the deck.

None of the above inventions and patents, taken either singly or in combination, is seen to describe the instant invention as claimed. Thus, a lawnmower and trimmer solving the aforementioned problems is desired.

### SUMMARY OF THE INVENTION

The lawnmower and trimmer combination apparatus comprises a lawnmower modified to incorporate a grass or weed trimmer. A first embodiment of the apparatus provides a slot on a front or sidewall of the lawnmower deck for providing space for the trimmer filament to protrude above or below the mower blade and has a trimmer housing on the deck. The trimmer housing may enclose a battery operated trimmer motor, which is controlled by an electric switch on the handle of the lawnmower. Alternatively, the trimmer housing may enclose a bearing and a shaft extending below the deck upon which the trimmer cutting head is mounted, the trimmer shaft being driven by a belt drive mechanism extending between the lawnmower power shaft and the trimmer shaft.

A second embodiment provides for rotation of the grass trimmer unit by a belt drive assembly that works off the rotation of the lawnmower's power shaft, combined with a tilting mechanism for the trimmer unit. The lawnmower may be operated in lawnmower mode only, or with the trimmer engaged by a pivoting pulley assembly controlled by a handle mounted lever connected to the pivoting pulley by a cable. A shroud on the deck can be added for providing space for the belt. A third embodiment provides a non-adjustable height trimmer unit positioned in a front left corner of the lawnmower deck, which may be driven either by a belt drive or an externally mounted trimmer motor.

The lawnmower may be powered by either a gasoline or an electric motor. The lawnmower may be a push lawnmower, or it may be a riding lawnmower.

Accordingly, it is a principal object of the present invention to provide a lawnmower and trimmer combination apparatus having the grass trimmer unit positioned in various locations of a lawnmower deck.

It is another object of the present invention to provide a lawnmower and trimmer combination apparatus for either a gasoline or electrically powered lawnmower.

It is a further object of the present invention to provide a first embodiment of a lawnmower and trimmer combination apparatus having a slot in a sidewall or front wall of the lawnmower deck for movement of the grass trimmer string above or below the cutter blade.

Still another object of the present invention is to provide a second embodiment of a lawnmower and trimmer combination apparatus wherein the grass trimmer unit is rotated and tilted by a belt drive assembly that works off the rotation of the lawnmower's power shaft.

A further object of the present invention is to provide a third embodiment of a lawnmower and trimmer combination apparatus having the trimmer unit located in a front left corner of a lawnmower having an offset wheel.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of a lawnmower and trimmer apparatus according to the present invention having a slot in a side of the deck.

FIG. 2 is a partial side perspective view of the FIG. 1 lawnmower deck and trimmer motor attachment.

FIG. 3 is a schematic, partially sectioned, top plan view of a lawnmower and trimmer of a second embodiment according to the present invention.

FIG. 4 is a schematic, partially sectioned view of the FIG. 3 embodiment lawnmower to illustrate the tilting aspect of the grass trimmer unit on the left side of the lawnmower as viewed from the rear.

FIG. 5 is a schematic top plan view of a third embodiment of a lawnmower and trimmer apparatus according to the present invention.

FIGS. 6A, 6B and 6C are sequential schematic top views of the operation of the belt tensioning mechanism.

Similar reference characters denote corresponding features consistently throughout the attached drawings.

### DETAILED DESCRIPTION OF THE PREFERRED EMBODIMENTS

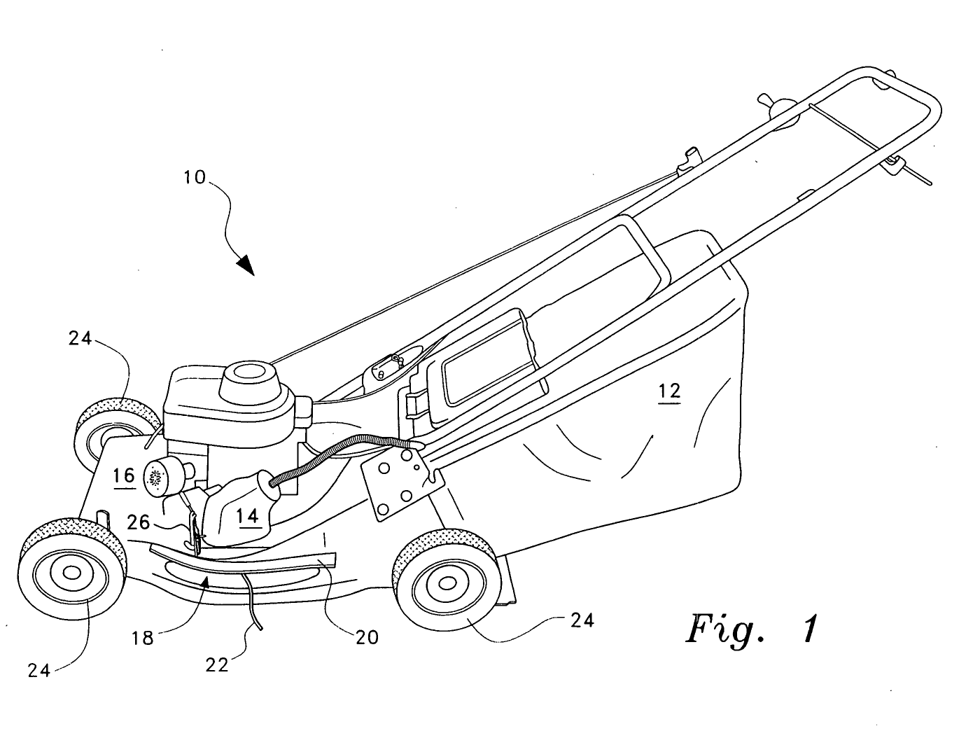

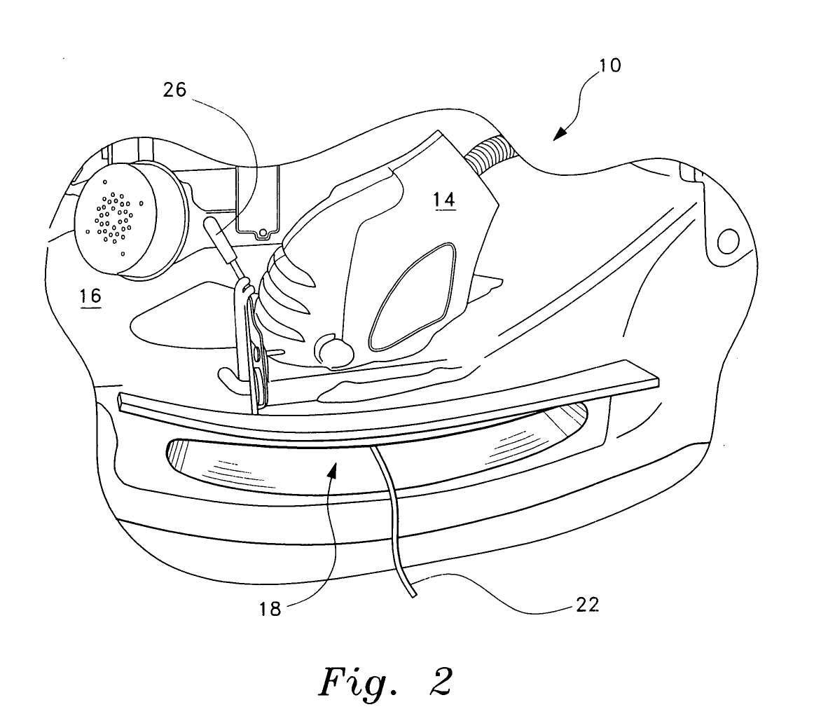

The present invention combines a lawnmower and a grass trimmer unit into one apparatus. A first embodiment of the apparatus is illustrated in FIGS. 1 and 2 to show a conventional hand-pushed gasoline engine lawnmower 10 having a grass collector bag 12 in the rear that is modified by the addition of a trimmer housing 14 to the deck 16. A longitudinal slot 18 is formed in the left side of the deck 16. A flat, horizontally aligned rectangular shield 20 is added above the slot 18 to aid in the suction of the trimmed grass into the interior of the deck 16. A cutting string 22 or other flexible cutting filament is shown extending out of the slot 18. The wheels 24 in this embodiment are conventionally located at the corners of the deck 16.

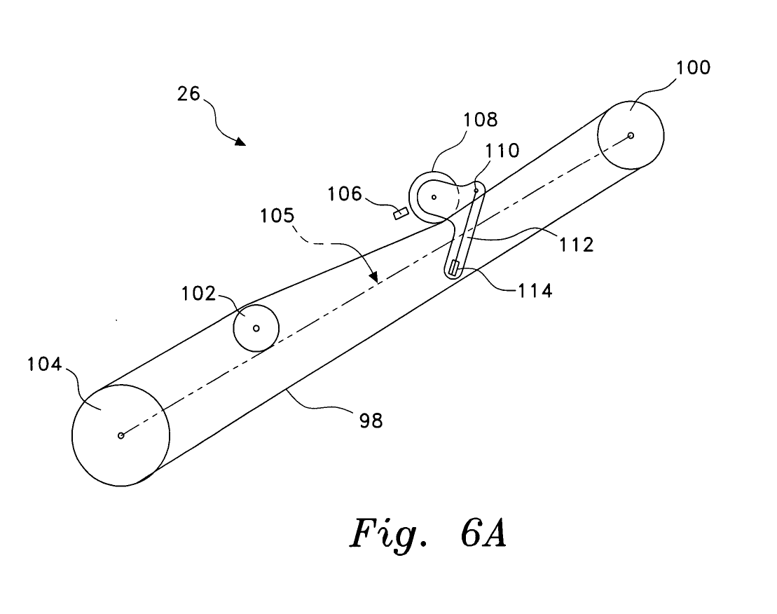

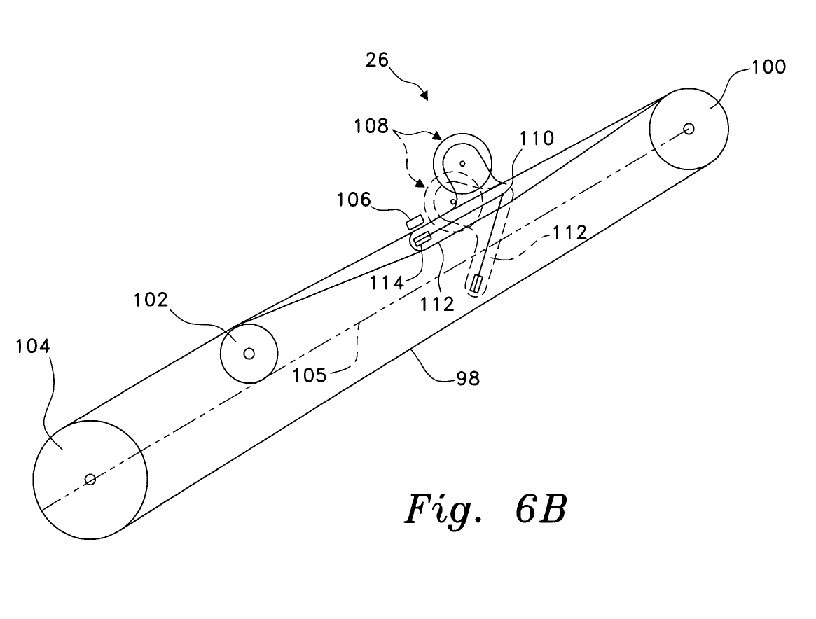

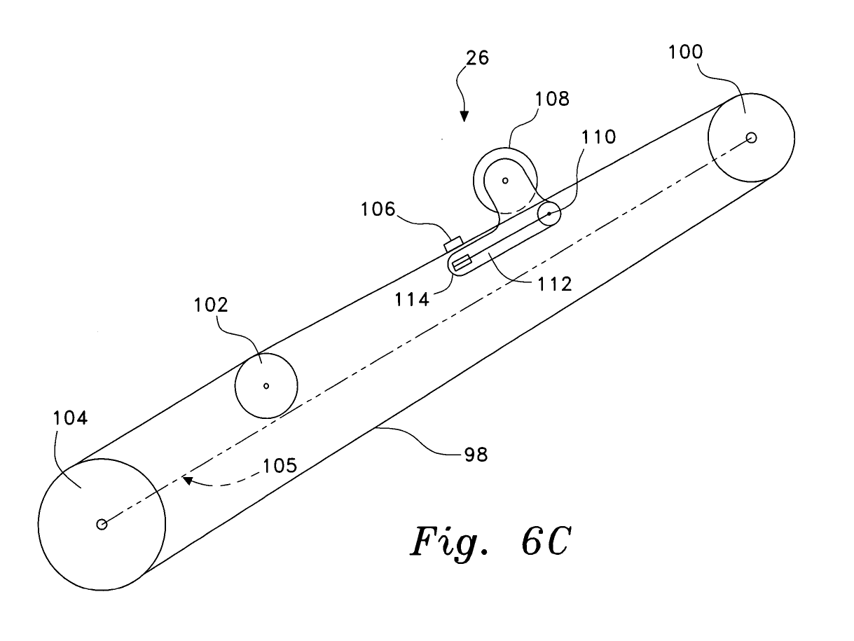

The trimmer housing 14 may enclose a trimmer motor, the trimmer shaft extending below the lawnmower deck and having a cutting head disposed thereon that dispenses the cutting filament 22. In such a case, the trimmer is operated by an electrical switch disposed upon the lawnmower handle in any conveniently accessible location. Alternatively, the trimmer may be powered by a belt drive mechanism of the type described below with reference to FIGS. 6A-6C. A lever 26 is provided for raising and lowering the height of the cutting filament 22 above or below the lawnmower blade.

It should be noted that the invention is not limited to a lawnmower that is pushed by hand and has a rear grass collector bag. The collection bag can be located on a lawnmower side opposite the slot. Also, other grass cutting apparatus, such as lawn tractors or riding lawnmowers can be modified as described above.

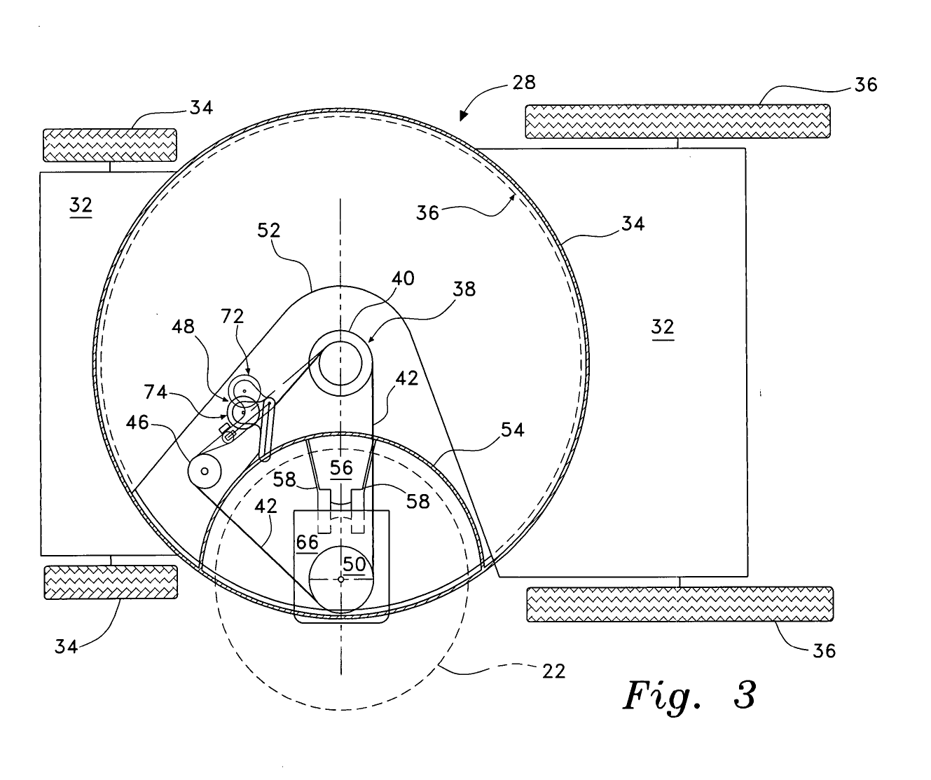

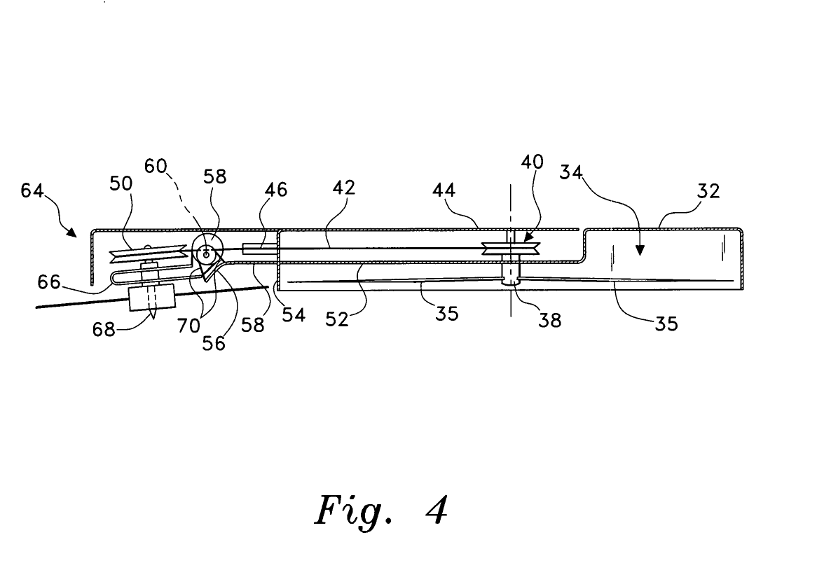

FIGS. 3 and 4 are directed to a second embodiment lawnmower and trimmer apparatus 28 having two tilting adjustment options of the grass trimmer unit 30. The engine and housing have been omitted for clarity. The design of the deck 32 is irregular with the front portion being more narrow with smaller diameter wheels 34 than the rear portion, which is wider and equipped with large diameter wheels 36, e.g., 14-inch wheels. The grass trimmer unit 30 is disposed on the left side and housed under the deck 32. The lawnmower blade housing 34 for the blade 35 is shown sectioned. The extended path of the lawnmower blade tip is indicated in dashed line 36 in FIG. 3.

The main drive shaft 38 has a first pulley 40 for the drive belt 42 under the main support platform 44 which is delineated by a V-shaped slot 45 in FIG. 3. Belt 42 traverses a second idler pulley 46 and a pivoting pulley assembly 48 positioned between the aforementioned pulleys which controls the activation and deactivation of the tilting grass trimmer unit 30. The drive belt 42 continues on to a third drive pulley 50 of the grass trimmer unit 30. The drive belt 42 thus forms a triangle as viewed in FIG. 3. A thin triangular non-centered metal plate 52 below the main support platform 44 has a metal semicircular vertical wall 54 and extends past the wall to form a downwardly depending lip 56 of an extension tongue 58. The lip 56 supports a third double pulley 58 separated by and connected to a third smaller diameter pulley 60 on a common axle 62 to form an adjustable tilting mechanism 64. A U-shaped plate 66 as viewed in FIG. 4 is attached to the tilting grass trimmer unit 30 by supporting the shaft 68.

The tilting mechanism 64 is supported by a tether 70 traversing shaft 60 and attached in two places on the lip 56 of the tongue 58 (FIG. 4). To stop the operation of the tilting trimmer unit 30 the pivoting pulley assembly 48 is manually moved from the run position 72 to the stop position 74 to release the tension of the drive belt 42 from the main drive shaft 38. Thus, the drive belt 42 no longer operates the tilting trimmer unit 30 while the lawnmower blade 35 can continue to cut grass.

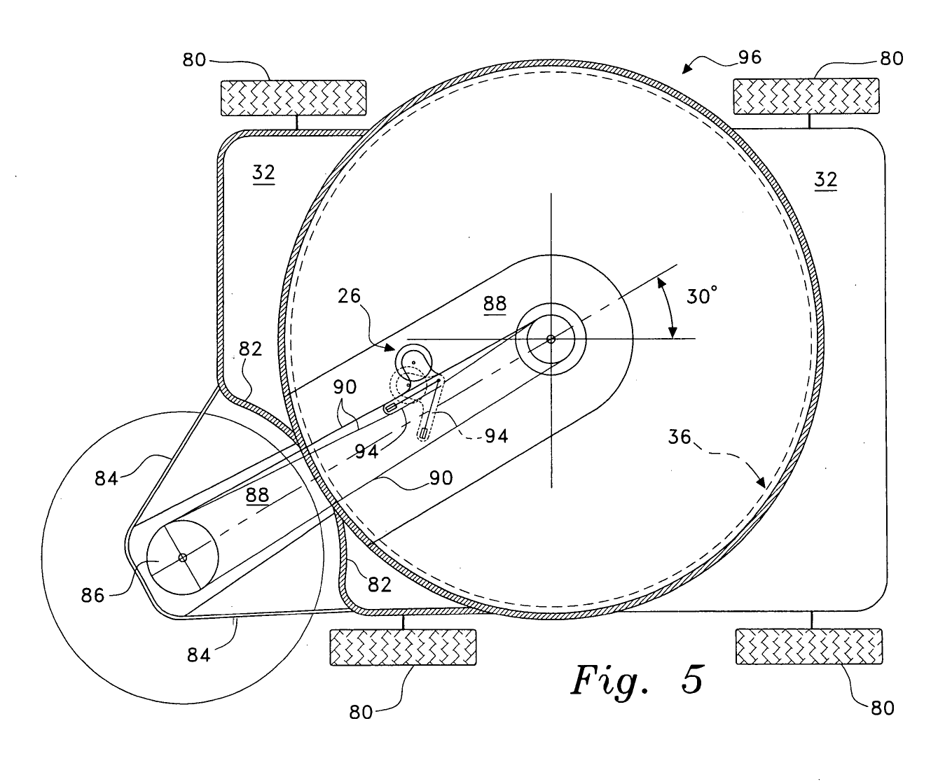

FIG. 5 is a third embodiment of a non-adjustable trimmer spool and lawnmower apparatus 76 which positions its grass trimmer unit 78 at the left front corner which is available space due to the offset left front wheel 80. The deck 32 (shown sectioned) has been modified to have an arcuate left front corner wall 82 (shown sectioned) abutting the deck 32. An outside vertical wall structure 84 surrounding the drive pulley 86 of the trimmer unit 78 is also supported by a horizontal metal plate 88. A drive belt 90 extending from the first pulley 92 of the main drive shaft 38 to the trimmer drive pulley 86 is controlled by a belt tensioner unit 26 on the U-shaped metal plate 88 placed above the deck 32. If the arm 94 of the belt tensioner unit 26 is applied to the drive belt 90 (shown in bold lines), the grass trimmer unit 78 is activated manually. When the arm 94 is manually moved to release tension on the drive belt 90 the grass trimmer unit 78 is deactivated. Thus, the third embodiment of a manually operated grass trimmer unit 78 integrated with the lawnmower unit 96 has been shown.

FIGS. 6A, 6B and 6C illustrate the control movements of a belt tensioner unit on a drive belt 98 traversing a lawnmower cutter's main drive pulley 100, an idler pulley 102, and a string cutter's drive pulley 104 centered on an axis line 105. The belt tensioner unit has a stationary brake block 106 attached to the underside of the mower deck. The unit has a pulley 108 mounted on an arm 112 the pivots about a pivot shaft 110, and a brake lock 114 or pad mounted at the end of arm 112 that is in alignment to stop against the stationary brake block 106.

FIG. 6A shows the pulley arm 112 pivoted so that the pulley 108 bears against the drive belt 98 thereby exerting tension on the belt and engaging the belt 98 against a pulley 100 mounted on the lawnmower power shaft, a pulley 104 mounted on the trimmer shaft, and an idler pulley 102, thereby rotating the trimmer shaft and the trimmer cutting head.

FIG. 6B illustrates the movement of the belt tensioning pulley 108 between an engaged position, shown in phantom lines, and a non-engaged position, shown in solid lines 98.

FIG. 6C depicts the belt tensioning pulley 108 after the arm 112 has been pivoted so that pulley 108 does not bear against drive belt 98. In this position the drive belt is raised slightly by pivoting of the arm 112 and is held by friction between the brake pad 114 and stationary brake block 106, so that the lawnmower pulley 100 no longer drives the trimmer pulley 104. The pivoting pulley arm 112 is manually controlled by the operator of the lawnmower using a lever mounted on the handle and a cable extending from the lever to the pivoting pulley arm 112, in a fashion similarly to the control mechanism for a self-propelled lawnmower. However, the lever controlling the pivoting pulley arm 112 may be locked into position so that the operator is not required to continuously depress the control lever for operation of the trimmer.

Three embodiments of a combination lawnmower and trimmer unit have been shown which enable an operator to readily cut grass and optionally trim simultaneously.

It is to be understood that the present invention is not limited to the embodiments described above, but encompasses any and all embodiments within the scope of the following claims.

1. A lawnmower and trimmer apparatus comprising:
a lawnmower having a deck a skirt depending therefrom, a plurality of wheels mounted to the deck, and a blade mounted on a rotatable power shaft beneath the deck, the skirt having a longitudinal slot defined therein extending between a front wheel and a rear wheel;
a trimmer housing disposed on the deck;
a trimmer cutting head mounted below the deck adapted for dispensing a cutting filament through the slot; and
means for selectively rotating the lawnmower blade alone and for rotating the lawnmower blade and the trimmer cutting head simultaneously;
whereby the apparatus can cut grass and simultaneously trim grass.

2. The lawnmower and trimmer apparatus according to claim 1, further comprising at least one guide plate attached inwardly from the slot.

3. The lawnmower and trimmer apparatus according to claim 1, further comprising a triangular shaped guide plate extending inwardly from a lower horizontal edge of the slot.

4. The lawnmower and trimmer apparatus according to claim 1, wherein the triangular shaped guide plate extends upwardly to the deck's interior wall.

5. The lawnmower and trimmer apparatus according to claim 1, further comprising height adjustment means mounted on the deck for adjusting the height of the filament.

6. The lawnmower and trimmer apparatus according to claim 1, wherein the lawnmower has a collection bag attached on a side of the deck opposite the trimmer apparatus.

7. The lawnmower and trimmer apparatus according to claim 1, wherein said means for selectively rotates comprises a trimmer motor mounted in the trimmer housing and an electrical switch mounted on a handle of the lawnmower electrically connected to the trimmer motor.

8. The lawnmower and trimmer apparatus according to claim 1, wherein said means for selectively rotating comprises a bearing mounted in the trimmer housing, a trimmer shaft mounted in the bearing and extending below the deck, and a belt drive assembly connecting the lawnmower power shaft to the trimmer shaft, the belt drive assembly including a pivoting belt tensioner pulley and a lever and cable connected to the belt tensioner pulley for selectively engaging and disengaging the belt drive assembly.

9. A lawnmower and trimmer apparatus comprising;
a hand or power propelled lawn mower machine having a circular main deck with a skirt, a centered main drive, and four wheels;
an internal deck formed from the periphery of a centered main lawnmower blade drive to a left front wheel region;
an enclosure hood depending from above the centered main drive to a left front wheel region;
the enclosure hood supporting a trimmer element tilted toward the lawnmower;
a first belt supported by a first horizontal pulley on the main drive and a second horizontal pulley on the trimmer element; and
an adjustable belt tensioner element for the first belt positioned below the deck with its control above the deck;
whereby the apparatus can cut grass at a predetermined height and simultaneously trim any grass on the left side.

10. The lawnmower and trimmer apparatus according to claim 9, wherein the enclosure hood extends from a right front wheel to an offset left front wheel.

11. The lawnmower and trimmer apparatus according to claim 10, wherein the offset left front wheel is closer to the left rear wheel then the right front wheel is to the right rear wheel.

12. The lawnmower and trimmer apparatus according to claim 9, wherein a third horizontal pulley is positioned in front of the deck and in-line with the first and second pulleys.

13. The lawnmower and trimmer apparatus according to claim 9, wherein an extension support extends from the left front corner of the deck and supports a fourth vertical pulley.

14. The lawnmower and trimmer apparatus according to claim 13, wherein the fourth vertical pivot pulley has a belt attached to a pivot mount of the trimmer element.

15. The lawnmower and trimmer apparatus according to claim 14, wherein an independent manual or automatic control controls the pivoting angle of the trimmer element.

16. The lawnmower and trimmer apparatus according to claim 9, wherein the cutter string of the trimmer element clears the deck upon rotation.

17. The lawnmower and trimmer apparatus according to claim 9, wherein a support wall surrounds the trimmer element and is connected to the deck.

18. The lawnmower and trimmer apparatus according to claim 9, wherein the apparatus is driven by electrical power.

19. The lawnmower and trimmer apparatus according to claim 9, wherein the apparatus is driven by a gasoline engine.
